(19) United States
(12) Patent Application Publication
(10) Pub. No.: US 2016/0355186 A1
(43) Pub. Date: Dec. 8, 2016

(54) ELECTRONIC CONTROL SYSTEMS FOR GROUNDS MAINTENANCE VEHICLE

(71) Applicant: THE TORO COMPANY, Bloomington, MN (US)

(72) Inventors: Allan Dale Kanitz, Lakeville, MN (US); Tanner Lee Erickson, Bloomington, MN (US); Dale A. Stover, Plymouth, MN (US); Todd A. Porter, Rosemount, MN (US)

(21) Appl. No.: 14/729,639

(22) Filed: Jun. 3, 2015

(51) Int. Cl. B60W 30/18; B60W 10/10; B60W 10/18; B60W 10/06

(52) U.S. Cl. CPC B60W 30/18; B60W 10/06; B60W 10/10; B60W 10/182; B60W 2540/00; B60W 2510/06; B60W 2510/101; B60W 2710/021

(57) ABSTRACT

Various embodiments of a grounds maintenance vehicle are disclosed. The grounds maintenance vehicle can include an electronic control unit (ECU) in electrical communication with a transmission control input, clutch, parking brake, and OP switch of the vehicle. In response to a pre-defined operator activity, the ECU is adapted to manipulate the clutch from an engaged state to a disengaged state, while an engine of the vehicle remains in an operative state, when the transmission control input is in a neutral state and the OP switch changes from an on state to an off state.

Embodiments described herein are directed generally to grounds maintenance vehicles, and, more particularly, to control systems for use with the same.

### BACKGROUND

Grounds maintenance vehicles such as lawn mowers are used by consumers and professional alike. These vehicles are typically configured as either walk-behind or ride-on vehicles having an implement (e.g., a grass cutting deck) attached thereto. Within the deck, cutting blades powered by an engine of the mower rotate at a speed sufficient to cut vegetation over which the deck passes during operation.

The mower deck may be powered by the engine via an implement drive system. Typically, a power take-off (PTO) clutch is provided to allow the implement drive system to selectively engage with, or disengage from, the engine. That is, when the clutch is engaged, the engine may effectively power the implement via the implement drive system. Such mowers may also include a parking brake that is manually engageable by the operator when the mower is stationary. The parking brake typically operates by effectively interfering with operation of a transmission of the mower.

Many conventional riding lawn mowers may require specific operator control interactions for effective mower operation. For example, many mowers require that the operator disengage a parking brake before transmission engagement. Other mowers may require that the operator terminate power to the implement (e.g., disengage the clutch) before leaving the operator platform, or disengage the clutch and engage the parking brake before starting the engine. If these actions are not taken in the correct order, the engine may be stopped (or, if not yet started, be disabled) until corrective actions are taken.

### SUMMARY

Embodiments described herein may provide a grounds maintenance vehicle. The vehicle can include an electronic control system having an electronic control unit (ECU) that is in electrical communication with one or more of a transmission control input, a power take off (PTO) clutch, a parking brake, and an operator presence (OP) switch. In one or more embodiments, the ECU can be adapted to manipulate the clutch from an engaged state to a disengaged state, thereby decoupling an engine of the vehicle from an implement supported by a chassis of the vehicle, when operator presence is no longer detected, e.g., when an operator of the vehicle has left an operator platform of the vehicle (e.g., a seat), i.e., the OP switch changes to an off state. Further, the ECU may allow the engine to remain in an operative state when the OP switch is in the off state.

In one aspect, the present disclosure provides a grounds maintenance vehicle that includes a chassis; an engine supported by the chassis, the engine including an operative state and an inoperative state; and an implement supported by the chassis. The grounds maintenance vehicle further includes a ground engaging drive member connected to the chassis and operable to propel the vehicle over a ground surface; a transmission operatively connected between the engine and the ground engaging drive member, where the transmission includes forward, neutral, and reverse states; a transmission control input operatively connected to the transmission, where the transmission control input includes forward, neutral, and reverse states corresponding to the forward, neutral, and reverse states of the transmission, respectively; and a clutch operatively connected between the engine and the implement, the clutch adapted for selective manipulation between a disengaged state, where the engine is operatively decoupled from the implement, and an engaged state, and where the engine is operatively coupled to the implement. The grounds maintenance vehicle also includes a parking brake having an engaged state adapted to immobilize the ground engaging drive member, and a disengaged state; an operator presence (OP) switch having an off state corresponding to an operator platform of the ground maintenance vehicle being vacant, and an on state corresponding to the operator platform being occupied; and an electronic control unit (ECU) in electrical communication with the transmission control input, clutch, parking brake, and OP switch. In response to a pre-defined operator activity, the ECU is adapted to manipulate the clutch from the engaged state to the disengaged state, while the engine remains in the operative state, when the transmission control input is in the neutral state and the OP switch changes from the on state to the off state.

In another aspect, the present disclosure provides a grounds maintenance vehicle that includes a chassis; an engine supported by the chassis and having an operative state and an inoperative state; and a ground engaging drive member connected to the chassis and operable to propel the vehicle over a ground surface. The grounds maintenance vehicle also includes a transmission operatively connected between the engine and the ground engaging drive member, where the transmission includes forward, neutral, and reverse states; a transmission control input mechanically connected to the transmission, where the transmission control input includes forward, neutral, and reverse states corresponding to the forward, neutral, and reverse states of the transmission, respectively; and a parking brake having an engaged state adapted to immobilize the ground engaging drive member, and a disengaged state. The grounds maintenance vehicle also includes an electronic control unit (ECU) in electrical communication with the transmission control input, parking brake, and OP switch; and an ignition switch in communication with the engine and the ECU, where the ignition switch includes an off state, a start state, and a run state, and where the engine is in the operative state when the ignition switch is in either the run state or the start state, and further where the engine is in the inoperative state when the ignition is in the off state. The ECU, in response to a pre-defined operator activity, is adapted to manipulate the parking brake to the engaged state when the ignition switch is manipulated from the off state to either the run state or the start state and the transmission control input is in the neutral state.

In another aspect, the present disclosure provides a grounds maintenance vehicle that includes a chassis; an engine supported by the chassis, the engine including an operative state and an inoperative state; and an implement supported by the chassis. The grounds maintenance vehicle further includes a ground engaging drive member connected to the chassis and operable to propel the vehicle over a ground surface; a transmission operatively connected between the engine and the ground engaging drive member, where the transmission includes forward, neutral, and reverse states; a transmission control input operatively connected to the transmission, where the transmission control input includes forward, neutral, and reverse states corresponding to the forward, neutral, and reverse states of the transmission, respectively; and a clutch operatively connected between the engine and the implement, the clutch adapted for selective manipulation between a disengaged state, where the engine is operatively decoupled from the implement, and an engaged state, and where the engine is operatively coupled to the implement. The grounds maintenance vehicle also includes a parking brake having an engaged state adapted to immobilize the ground engaging drive member, and a disengaged state; an operator presence (OP) switch having an off state and an on state; and an electronic control unit (ECU) in electrical communication with the transmission control input, clutch, parking brake, and OP switch. In response to a pre-defined operator activity, the ECU is adapted to manipulate the clutch from the engaged state to the disengaged state, while the engine remains in the operative state, when the transmission control input is in the neutral state and the OP switch changes from the on state to the off state.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a perspective view of a grounds maintenance vehicle, e.g., a riding lawn mower, incorporating an electronic control system in accordance with one embodiment of the disclosure.

FIG. 2 is a partial top plan view of the grounds maintenance vehicle of FIG. 1.

FIG. 3 is a partial bottom perspective view of the grounds maintenance vehicle of FIG. 1.

FIG. 4 is a diagrammatic view of the grounds maintenance vehicle of FIG. 1.

FIGS. 5A-B combined define a flow chart of one embodiment of method logic for an electronic control system for controlling various aspects of the ground control maintenance vehicle of FIG. 1, wherein connecting elements A, B, and C are used to link FIG. 5A to FIG. 5B.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing that form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities (e.g., intervals of time), and all terms expressing direction/orientation (e.g., vertical, horizontal, parallel, perpendicular, etc.) in the specification and claims are to be understood as being modified in all instances by the term “about.”

In general, the present disclosure provides various embodiments of a grounds maintenance vehicle. The vehicle can include an electronic control system having an electronic control unit (ECU) that is in electrical communication with one or more of a transmission control input, a power take off (PTO) clutch, a parking brake, and an operator presence (OP) switch. In one or more embodiments, the ECU can be adapted to manipulate the clutch from an engaged state to a disengaged state, thereby decoupling an engine of the vehicle from an implement supported by a chassis of the vehicle, when operator presence is no longer detected, e.g., when an operator of the vehicle has left an operator platform of the vehicle (e.g., a seat), i.e., the OP switch changes to an off state. Further, the ECU may allow the engine to remain in an operative state when the OP switch is in the off state.

In typical riding grounds maintenance vehicles, an operator is generally required to turn off an implement, e.g., mowing deck, and engage the parking brake when leaving a seat or platform of the vehicle to, e.g., clear debris or other obstructions from a desired path of the vehicle. If the operator forgets one of these steps, then the engine may shut off. Further, in typical ground maintenance vehicles, the operator may also be required to apply the parking brake before the engine is started. Failure to do so may engage an interlock that prevents the engine from starting. While such procedures are effective, some operators may find them frustrating.

One or more embodiments of the grounds maintenance vehicles described herein can, however, automate some of these procedures, thereby alleviating the operator from performing various actions. For example, grounds maintenance vehicles in accordance with embodiments of the present disclosure may include an ECU capable of automatically engaging the parking brake and turning off the implement while keeping the engine running (e.g., while maintaining the engine in an operative state) when the operator leaves the operator platform. The operator, therefore, can step off of the vehicle and remove obstacles in the vehicle's path without having to either disengage the PTO clutch upon egress from the operator platform or restart the vehicle engine upon ingress to the operator platform. Further, in one or more embodiments, the ECU can also be adapted to engage the parking brake automatically after the vehicle is turned off, i.e., when the engine changes to a inoperative state. In one or more embodiments, the ECU can be adapted such that the parking brake is automatically disengaged when a transmission control input (e.g., a foot pedal) is momentarily tapped or engaged (e.g., moved to either a forward or reverse state) and then returned to the neutral state. And in one or more embodiments, the vehicle can be adapted to automatically engage the parking brake when the operator manipulates an ignition switch to a start state.

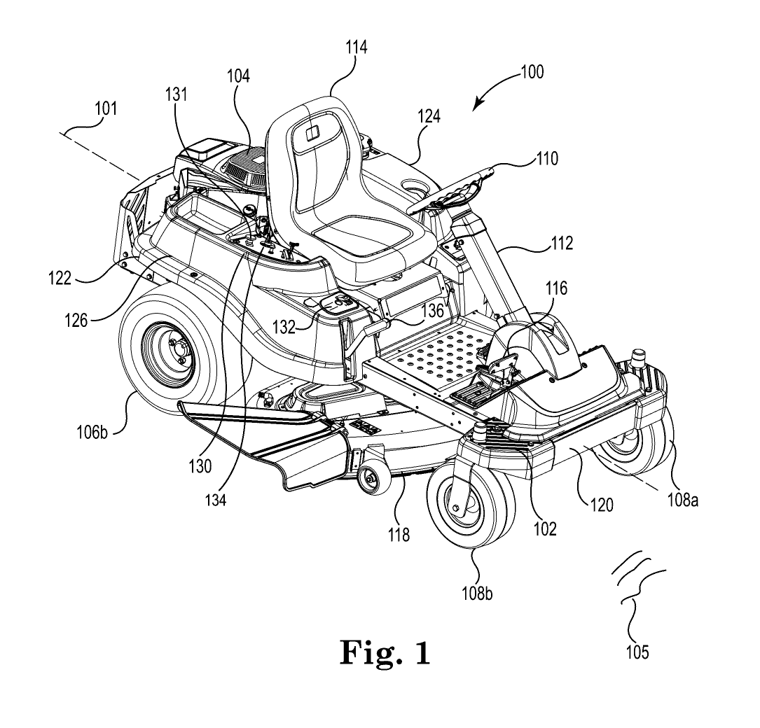

Any suitable grounds maintenance vehicle can be adapted to utilize one or more of these features described herein. For example, FIGS. 1-3 illustrate various views of a grounds maintenance vehicle, e.g., riding lawn mower 100, in accordance with one or more embodiments of the disclosure. While the general construction of the mower 100 is not necessarily central to an understanding of exemplary embodiments (e.g., other mower and other vehicle configurations are certainly contemplated), the general construction of the mower 100 is briefly described herein.

The mower 100 may include a chassis 102. While the mower 100 shown and described herein is a self-propelled riding or ride-on lawn mower (also referred to herein simply as a “mower” or “vehicle”), such a configuration is not limiting. That is, while embodiments are described herein with respect to a ride-on mower, those of skill in the art will realize that embodiments of the present disclosure may find applicability to other types of ride-on (e.g., sit-on, stand-on, or ride-behind) or walk-behind turf-care or grounds maintenance vehicles/equipment, including skid-steer vehicles, aerators, material spreader/sprayers, de-thatchers, snow throwers, and debris management systems, to name a few.

It is noted that the terms “comprises” and variations thereof do not have a limiting meaning where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the mower 100 while the mower is in an operating configuration, e.g., while the mower 100 is positioned such that wheels 106 and 108 rest upon a generally horizontal ground surface 105 as shown in FIG. 1. These terms are used only to simplify the description, however, and not to limit the interpretation of any embodiment described.

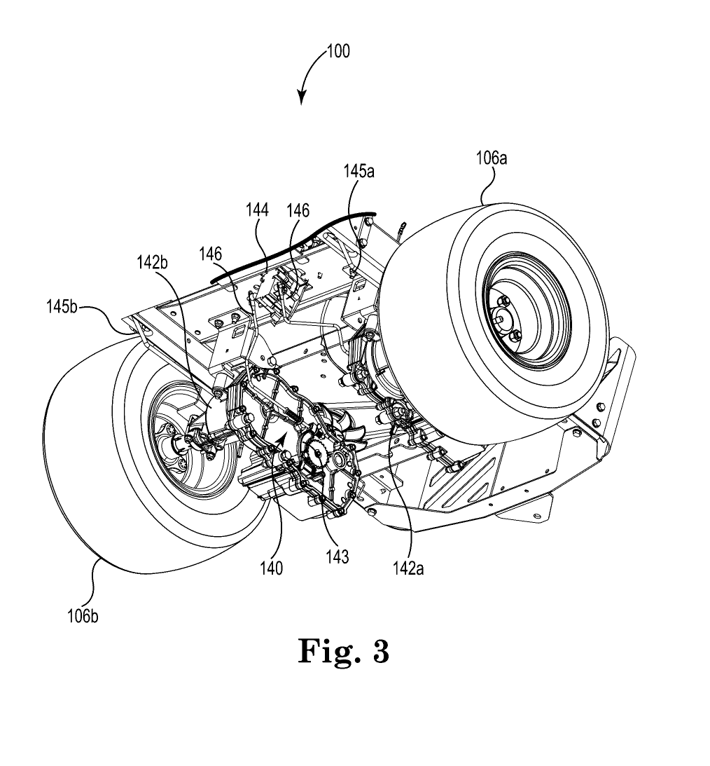

The chassis 102 may support a prime mover (e.g., internal combustion engine or “engine”) 104, which may, in one or more embodiments, be located at or near a rear end 122 of the vehicle 100 as indicated in FIG. 1. Left and right ground engaging drive members (e.g., rear drive wheels 106a, 106b (see also FIG. 3), collectively referred to as ground engaging drive members 106) may be rotatably coupled to the left and right sides 124, 126, respectively, of the chassis 102. Each drive wheel 106 may be powered to rotate, relative to the chassis 102, about a fixed axis such that simultaneous and equal rotation of the two drive wheels causes the vehicle 100 to move straight ahead (e.g., parallel to or along a longitudinal axis 101 of the mower 100). Although described herein as an internal combustion engine 104, other embodiments could utilize other prime movers, e.g., an electrical power source or hybrid power source, to power the drive wheels 106. In addition, while illustrated as wheels 106, other embodiments may utilize other drivers (e.g., tracks or the like) without departing from the scope of this disclosure.

In one or more embodiments, the mower 100 may be configured as a zero-turn radius (ZTR) mower, where the drive wheels 106 are independently driven, by a transmission that includes one or more (e.g., two) drive units powered by the engine 104. For example, as shown in FIG. 3, the transmission may be configured as two independent hydrostatic drive units 142a, 142b.

The suffixes “a” and “b” may be used throughout this description to denote various left- and right-side parts/features, respectively. However, in most pertinent respects, the parts/features denoted with “a” and “b” suffixes are generally identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

The mower 100 can also include one or more, e.g., two, support wheels 108a and 108b (herein collectively referred to as support wheels 108). In the illustrated embodiment, the support wheels 108 are located forward of the drive wheels 106 (e.g., during normal forward travel of the mower) and are thus referred to herein as “front” wheels (however, such a configuration is not limiting as, e.g., the positions of the drive wheels and the support wheels could be reversed). The front wheels 108 may be actively steered during operation or, alternatively, passive, e.g., caster wheels.

Accordingly, the drive wheels 106 may support a rear portion of the mower 100 in rolling engagement with a ground surface 105, while the front wheels 108 may likewise support a front portion of the mower. Of course, while described herein as utilizing two rear drive wheels 106 and two front support wheels 108, such a configuration is merely exemplary. For example, other embodiments may use more or fewer wheels (e.g., a tri-wheel configuration), while still other embodiments may provide different drive wheel configurations (e.g., front wheel drive or all-wheel drive) or different steering configurations (e.g., a vehicle having two independent steering control levers). Moreover, aspects of the present disclosure may find application to non-driven (e.g., operator push-powered) vehicles.

An implement, e.g. cutting deck 118, may be mounted to a lower side of the chassis 102, e.g., between the drive wheels 106 and the support wheels 108. The cutting deck 118 may include a housing having one or more cutting blades (not shown) as are known in the art. The cutting blades may be operatively powered, via spindles connected to the deck, by the engine 104. During operation, power is selectively delivered to the cutting deck 118 (e.g., via a belt or other power transmission device), whereby the blades rotate at a speed sufficient to sever grass and other vegetation over which the cutting deck passes during operation. While shown as a mid- or belly-mount deck, other embodiments may position the deck in other locations, e.g., forward of the front wheels 108, aft of the rear wheels 106, lateral to the chassis 102, etc. A mowing height of the cutting deck 118 relative to the ground surface 105 can be adjusted by the operator using, e.g., mowing height adjustment lever 136 (see FIG. 1).

The mower 100 may further include one or more vehicle/implement controls. For example, the vehicle 100 may include a steering wheel 110 rotatably attached to the chassis 102 by a steering column 112. The steering wheel 110 may be operable to control the differential rotation of the drive wheels 106 (e.g., via manipulation of the mower's drive system) and/or a steering angle (e.g., heading) of the front wheels 108. While illustrated herein as incorporating a steering wheel 110, other controls, e.g., single or multiple joysticks or joystick-type levers, separate drive or “stick” control levers, touchpads, etc., may also be used to control one or both of mower speed and direction.

The mower 100 can also include additional controls. For example, the vehicle 100 may include a control panel 130 that includes various additional controls regarding various vehicle systems. The control panel 130 can include operator selectable controls (e.g., switches, buttons, levers, etc.) adapted to provide inputs to the mower and/or the electronic control system of the mower. As is further described herein, the control panel 130 may, in one embodiment, include one or more of a power takeoff (PTO) control or switch, an ignition switch, and a parking brake switch. Other controls, e.g., engine speed, may also be included on the control panel 130.

The control panel 130 may be positioned on the vehicle 100 at a location accessible to the operator while the operator is located on an operator platform that, in one embodiment, is configured as a seat 114 attached to the chassis 102. In addition, the control panel 130 can include one or more informational displays to relay various vehicle parameters to the operator, e.g., engine run time (hour meter), fuel level, battery status, clutch mechanism status, parking brake status, etc. Optionally, warning indicators (e.g., lights) may also be provided to indicate parameters such as engine fault codes, elevated engine temperature, and low oil pressure.

The various controls and switches described herein can include any suitable configuration. For example, any switch or combination of switches or switch-like devices capable of together providing multiple settings described herein are possible without departing from the scope of the disclosure. For example, any switch described herein can be adapted as a momentary switch, a rotary switch with multiple detent positions, a lever having distinct detent positions, a sliding knob with distinct detent positions, a depress and hold switch, a capacitive touch switch, and a bump up switch.

As stated herein, the control panel 130 can include a user-selectable clutch engagement or PTO switch 131. The PTO switch 131 may selectively couple/decouple the engine 104 from the cutting deck 118 (e.g., the PTO switch may turn the deck on or off). The PTO switch 131 may, in the illustrated embodiment, be adapted as a mechanical momentary (e.g., push/pull) switch, although once again, most any type of switch or input mechanism is contemplated. While described as a mechanical switch that is physically movable between different switch positions, other embodiments may utilize a non-movable switch for the PTO switch 131. As a result, the term “position” is understood to also include any distinct setting or output provided by a nonmovable switch. In addition, the term “movable” and its variations can be understood to include any manipulation of the switch that results in altering the switch's setting or output, regardless of whether this manipulation is accompanied by any physical movement of the switch.

In the embodiment illustrated in FIGS. 1-3, the mower 100 also includes an ignition switch 134, which in the illustrated embodiment is disposed on control panel 130 (see FIG. 1). The ignition switch 134 can be in electrical and/or mechanical communication with the engine 104. In one or more embodiments, the ignition switch 134 can include an off state, a run state, and a start state. When the ignition switch 134 is in the off state, the engine is in the inoperative state, i.e., the engine is incapable of running. When the ignition switch 134 is in the run state, the engine is in the operative state, i.e., the engine is capable of running. Further, when the ignition switch 134 is in the start state (and other conditions described herein have been met), the engine 104 is again in the operative state (i.e., is capable of being started).

FIG. 3 is a perspective view of a bottom portion of the mower 100. The mower 100 includes the transmission illustrated as two independent drive units 142 (142a, 142b), where each drive unit is connected to its respective drive wheel 106 (e.g., left drive unit 142a is connected to left drive wheel 106a, and right drive unit 142b is connected to right drive unit 142b). The transmission (e.g., drive units 142) may include any suitable mechanism for providing power to the ground engagement drive members 106. For example, each drive unit 142 may be a hydrostatic drive unit as shown. Alternatively, transmissions in accordance with other embodiments of the present disclosure could include one or more hydraulic motors/pumps, an integrated hydrostatic transaxle, electrical drive units, mechanical drive units, or the equivalent. The drive units 142 may be operatively connected, e.g., via links 145 (145a, 145b), to a transmission control input (e.g., foot pedal) as further described herein. The transmission control input may manipulate the transmission (e.g., each drive unit 142 independently) to propel the vehicle and effect vehicle turns.

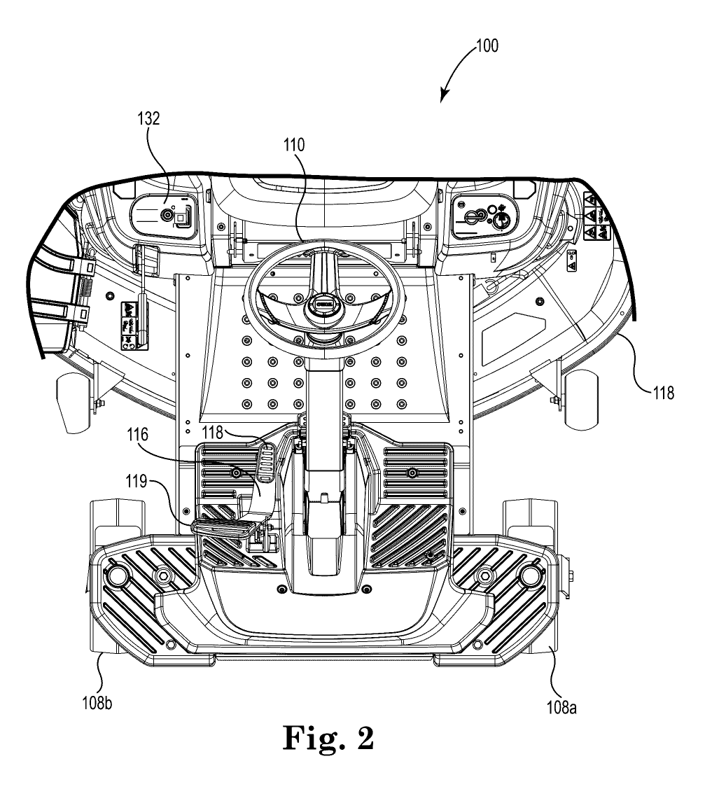

In one or more embodiments, the mower 100 also includes a parking brake switch 132 (see FIG. 2). The parking brake switch 132, like the other switches described herein, can include any suitable switch or combination of switches. The parking brake switch 132 may allow the operator to manipulate a parking brake such as parking brake 140 illustrated in FIG. 3 (portions of the parking brake associated with the left drive unit 142a are not visible in this view, but would be similar or identical to the portions associated with the right drive unit 142b, which is illustrated) between an engaged state and a disengaged state. In the engaged state, the parking brake 140 is adapted to immobilize the ground engaging drive members 106 (e.g., by locking an output shaft of the transmissions 142a, 142b), thereby preventing the drive members from rotating relative to the chassis 102. Further, in the disengaged state, the parking brake 140 does not interfere with rotation of the ground engaging drive members 106, e.g., the drive members are capable of rotating relative to the chassis 102.

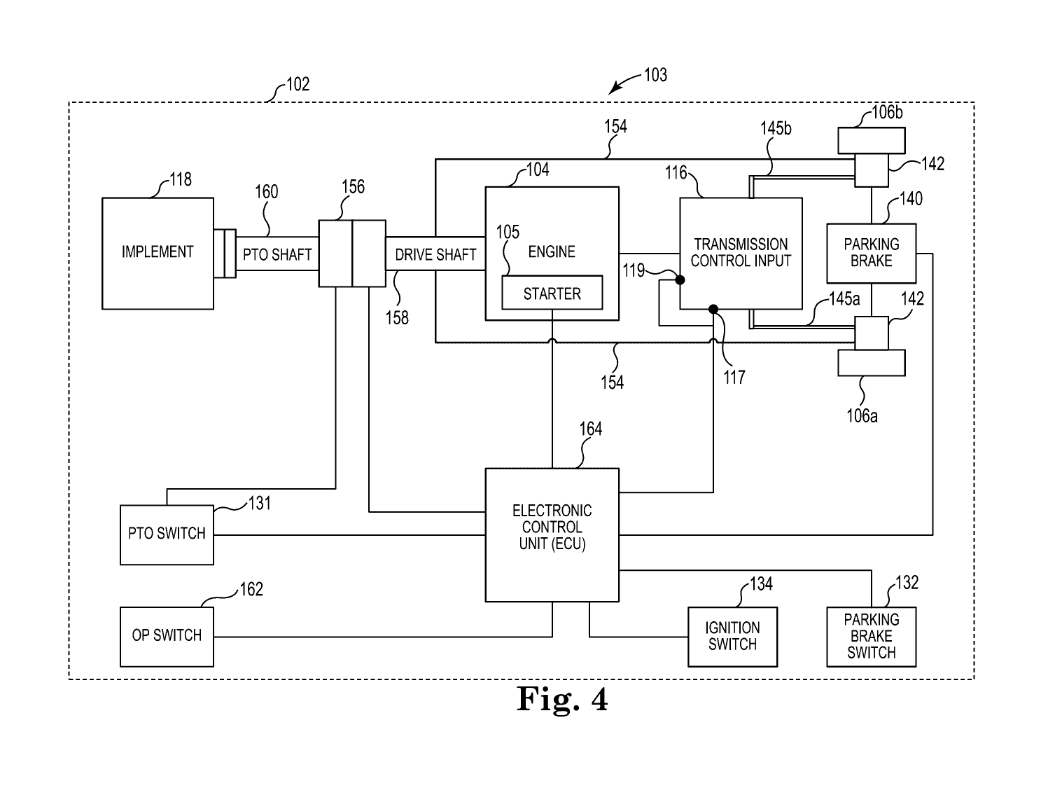

In one embodiment, the parking brake 140 includes a lock element 143 (see, e.g., FIG. 3) on each of the hydrostatic drive units 142, and an actuator 144 connected to each lock element by a connecting rod 146. The actuator may, under control of an ECU 164 (see, e.g., FIG. 4), displace the connecting rods 146, thereby engaging or disengaging the parking brake. Exemplary parking brakes may be disclosed in U.S. Pat. Nos. 6,739,116 and 8,573,368 (both to Stover et al.).

The mower 100 can further include a transmission control input 116 connected to the chassis 102. In one embodiment, the transmission control input 116 is configured as a foot pedal 116 (see, e.g., FIGS. 1-2) pivotably attached to the chassis 102 and pivotable in a first direction to effect forward propulsion, and a second direction to effect reverse propulsion. As the transmission control unit 116 pivots, it may displace links 145a, 145b (see FIG. 3), thereby causing the drive units 142 to rotate their respective drive wheels 106. That is to say, the transmission control input (e.g., pedal 116) may have a forward state, a neutral state, and a reverse state that correspond to or cause the transmission (e.g., the respective drive units 142) to be in a forward state, a neutral state, and a reverse state, respectively. The transmission control input 116 can include one or more switches (e.g., switches 177 and 119 of FIG. 4) that are in electrical communication with the ECU 164. In one or more embodiments, the one or more switches 117, 119 can indicate to the ECU 164 the state of the transmission control input, e.g., whether the control input is in the forward state, reverse state, or neutral state.

For example, in one or more embodiments, the operator can apply a force to a top portion of the pedal 116 to place the pedal, and thus the transmission, in the forward state, where the ground engaging drive member 106 propels the vehicle 100 in a forward direction relative to the operator positioned in the seat 114 and facing the steering wheel 110. Further, the operator can apply force to a lower portion of the pedal 116, thereby placing the transmission in the reverse state such that the ground engaging drive member 106 propels the vehicle 100 in a reverse direction relative to the operator being positioned in the seat 114 and facing the steering wheel 110. In one or more embodiments, the pedal 116 can be biased to the neutral state when the operator is not applying a force to the pedal.

FIG. 4 is an exemplary, partial schematic diagram of the grounds maintenance vehicle (e.g., mower 100) illustrating an electronic control system 103 in accordance with one embodiment of the disclosure. As shown in this view, the mower 100 includes the engine 104 supported by the chassis. The engine 104 may be set to either the operative state (where it is running or at least capable of running) or the inoperative state (where it is incapable of running) The mower 100 can also include the implement (e.g., cutting deck 118) also supported by the chassis 102. The ground engaging drive members 106, which are also shown, can be connected to the chassis 102. The mower 100 may also include the transmission control input (e.g., pedal 116) connected to the transmission (e.g., to the separate drive units 142) via respective links 145.

In the illustrated embodiment, the mower 100 may be adapted such that it is driven by drive units 142 (e.g., a dual hydrostatic drive system) that are each powered by the engine 104 via any suitable drive belt or linkage system 154. Each drive unit 142 can independently control the speed and rotational direction of its respective ground engaging drive member 106 based upon input provided by the operator, e.g., via the pedal 116 and steering wheel 110 of FIG. 1. Accordingly, the mower 100 may be directed over the ground surface 105 in the desired direction and at the desired speed via the drive units 142.

To selectively provide power to the implement (e.g., cutting deck 118 of FIG. 1), the engine 104 may include an output or driveshaft 158 adapted to selectively couple to an implement drive system (e.g., PTO shaft 160) under the control of the PTO clutch mechanism (clutch 156). In one or more embodiments, the implement drive system 160 can include a conventional shaft drivingly connected to the implement and selectively rotated by the engine 104 when the clutch 156 is engaged. In another embodiment, the implement drive system 160 can include a sheave and a belt (not shown). In the case of the latter, the clutch 156 can selectively cause the sheave to couple/decouple from the engine drive shaft 158.

As used herein, the term “clutch” can include any electrically controlled transmission or coupling system, e.g., a conventional electromagnetic clutch. In the embodiment illustrated in FIG. 4, the clutch 160 is configured as an electromagnetic PTO clutch operatively connected between the engine 104 and the cutting deck 118. The clutch 156 can be adapted for selective manipulation between a disengaged state, where the engine is operatively decoupled from the implement 118 (e.g., cutting deck), and an engaged state, where the engine is operatively coupled to the implement. In embodiments where the mower 100 includes an electric or hybrid motor system, the “clutch” 160 may include a switch or combination of switches that control delivery of energy being provided to the cutting deck 118 (or other suitable implement).

To energize the clutch 156 (e.g., to place the clutch into an engaged state where it mechanically couples the engine 104 to the implement 118), an electric signal (e.g., current) is provided to the clutch, producing a magnetic field that draws two clutch components tightly together, effectively permitting transmission of rotational power through the clutch. To de-energize the clutch 156 (e.g., to place the clutch into a disengaged state whereby the engine is decoupled from the cutting deck 118), the electric signal is terminated. Once the signal is so terminated, the clutch components may separate, mechanically disconnecting the cutting deck 118 from the driveshaft 158. In the illustrated embodiment, the disengaged state of the clutch 156 corresponds to an off state of the PTO switch 131, while the engaged state corresponds to an on state of the PTO switch.

Still referring to FIG. 4, the engine 104 may include a starter 105 in communication with the ignition switch 134 (e.g., via the ECU 164). The starter 105 may be used to selectively start the engine 104, e.g., when the ignition switch 134 is placed in the “start” state.

The grounds maintenance vehicle 100 may also include the parking brake 140 (see, e.g., FIGS. 3-4). The parking brake 140 can be in electrical communication with the ECU 164 as shown. In one or more embodiments, the parking brake 140 can have an engaged state that is adapted to immobilize the ground engaging drive member 106 (via locking of the respective drive units 142), and a disengaged state, where the parking brake is adapted to permit rotation of the ground engaging drive members.

The ground maintenance vehicle 100 can also include an operator presence (OP) switch 162. The OP switch 162 can be coupled to the operator platform (e.g., to the seat 114), using any suitable technique or combination of techniques, e.g., mechanical coupling, electrical coupling, etc. The OP switch 162 can have an off state corresponding to an operator platform of the ground maintenance vehicle (e.g., seat 114) being vacant, and an on state corresponding to the operator platform being occupied. For example, in embodiments of the mower 100 that include the seat 114, the OP switch 162 can be adapted to determine whether an operator is present in the seat. The OP switch 162 can include any suitable switch or combination of switches or other devices capable of determining the presence of an operator on the operator platform. In other embodiments (e.g., a walk-behind mower), the OP switch 162 can be a bail-activated switch or the like that the operator engages while walking behind the mower 100. In such embodiments, the OP switch 162 would be in the on state when the operator engages the bail, and is in the off state when the operator disengages (e.g., releases) the bail.

As illustrated in FIG. 4, the mower 100 may also include the ECU 164, which may be in electrical communication with one or more of the engine 104, the transmission control input 116, the clutch 156, the parking brake 140, the OP switch 162, and the PTO switch 131. The ECU 164 can include any suitable electronic component or components that are adapted to receive one or more inputs and control one or more devices of the mower 100, e.g., one or more microprocessors, controllers, integrated circuits, relays, switches, etc.

In one or more embodiments, the ECU 164 can be adapted to manipulate the clutch 156 from the engaged state to the disengaged state when the OP switch 162 is in the off state and the transmission control input 116 is in the neutral state as is further described herein. The ECU 164 can be adapted to manipulate the clutch 156 in response to any suitable pre-defined operator activity. As used herein, the phrase “pre-defined operator activity” can include any activity involving the operator interacting with the mower 100. For example, a pre-defined operator activity can include the operator entering (or vacating) the operator platform 114, the operator engaging (or disengaging) the PTO switch 131, the operator manipulating the ignition switch 134, etc. In one or more embodiments, the ECU 164 can manipulate the clutch 156 in response to a pre-defined operator activity, while the engine 104 remains in the operative state. In other words, the engine 104 may be allowed to remain in the operative state (e.g., running) even though the OP switch 162 changes from the on state to the off state, indicating that the operator is no longer present on the operator platform (at least while the transmission control input 116 is in the neutral state). Such a configuration may allow the operator to leave the operator platform to, e.g., to remove one or more obstacles from the path of the mower 100 without the engine being automatically inoperative, which would require the operator to restart the engine when resuming operation of the mower.

When the transmission control input 116 is, alternatively, in either the forward state or the reverse state, the ECU 164 can also manipulate the clutch 156 from the engaged state to the disengaged state and manipulate the engine 104 from the operative state to the inoperative state when the OP switch 162 moves from the on state to the off state. The ECU 164 can include any suitable delay after the OP switch 162 changes from the on state to the off state before the clutch 156 is disengaged and/or the engine 104 is manipulated to the inoperative state, e.g., a delay of greater than or equal to 0 seconds and no greater than 5 seconds, e.g., 0.5 seconds.

Further, when the transmission control input 116 is in either the forward state or the reverse state, the ECU 164 to manipulate the clutch 156 from the engaged state to the disengaged state and maintain the engine 104 in the operative state if the OP switch 162 is in the off state for a desired length or period of time, e.g., greater than or equal to 0 seconds and no greater than 0.5 seconds, e.g., 0.2 to 0.5 seconds.

In one or more embodiments, the ECU 164 can also be adapted to manipulate the parking brake 140 between the engaged state and the disengaged state. For example, in one or more embodiments, the ECU 164 can manipulate the parking brake 140 from the disengaged state to the engaged state when the engine 104 is in the inoperative state, e.g., automatically when the operator manipulates the ignition switch to the off state. Once again, any suitable length of time can be selected between the ignition switch being manipulated to the off state and engagement of the parking brake 140, e.g., greater than or equal to 0 seconds, no greater than 10 seconds, etc. For example, in one or more embodiments, the ECU 164 is adapted to manipulate the parking brake 140 from the disengaged state to the engaged state when the engine 104 is in the inoperative state for at least five seconds, seven seconds, etc.

Further, for example, the ECU 164 can be adapted to manipulate the parking brake 140 from the disengaged state to the engaged state, e.g., when both the OP switch 162 is moved to the off state and the transmission control input 116 is in the neutral state. In other words, the ECU 164 can engage the parking brake 140 when the operator leaves the operator platform 114 while the transmission control input 116 is in the neutral state. Any suitable length of time or delay can be selected between when the OP switch 162 is moved to the off state and when the ECU 164 engages the parking brake, e.g., greater than or equal to 0 seconds and no greater than 5 seconds. In one or more embodiments, the ECU 164 is adapted to manipulate the parking brake 140 from the disengaged state to the engaged state 1 second after the OP switch 162 is moved to the off state (assuming the transmission control input is in the neutral state).

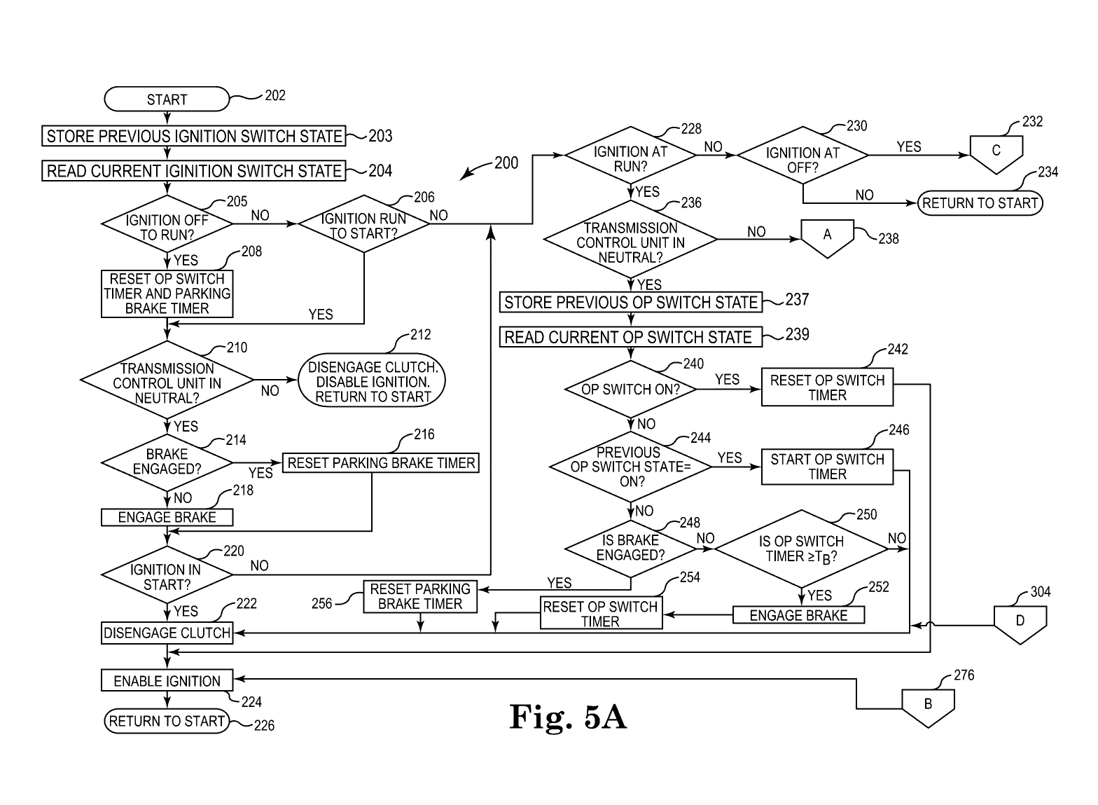

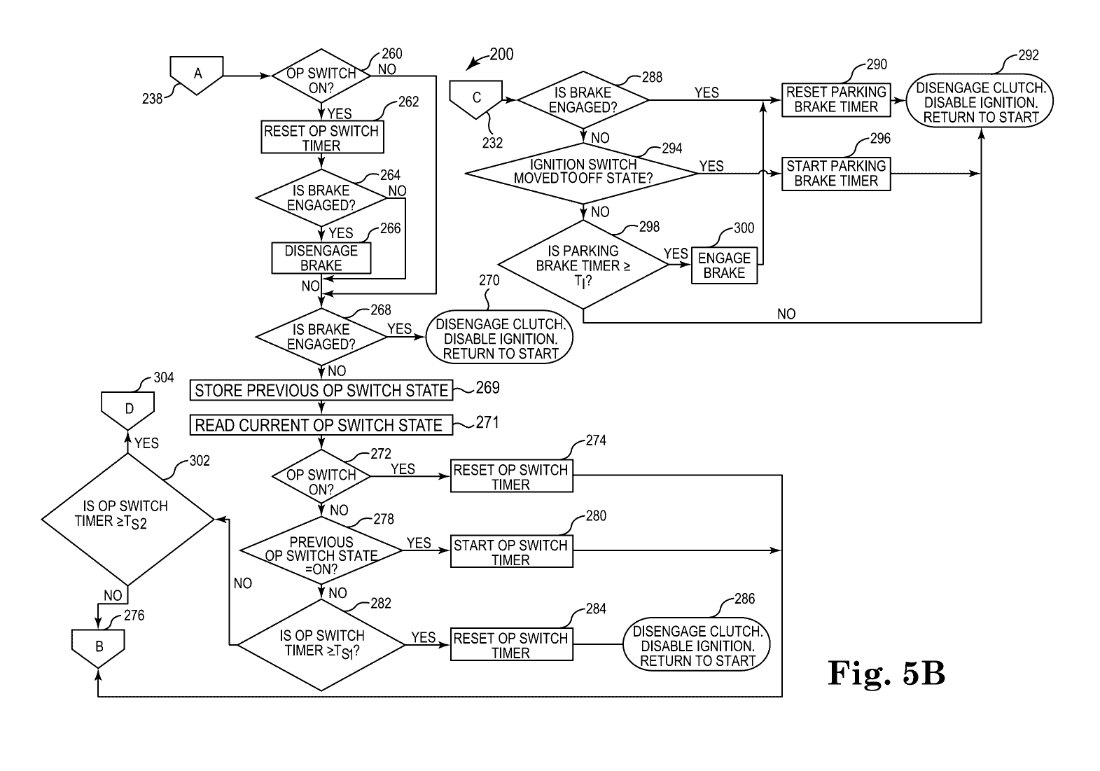

The ECU 164 can include any suitable logic or programming that is adapted to provide the desired control of the various elements of the mower 100. For example, FIGS. 5A-B provide an exemplary flowchart illustrating logic 200 of the ECU 164 in accordance with one embodiment of the present disclosure. The control procedure is entered at 202. At 203, the ECU stores a previous ignition switch state. At 204, the ECU 164 reads the current ignition switch state. The ECU 164 may then determine whether the ignition switch 134 has been manipulated from the off state to the run state at 205. If the ignition switch 134 has been manipulated from the off to the run state at 205, then an optional OP Switch Timer and Parking Brake Timer can be reset at 208. In one or more embodiments, OP Switch Timer can be utilized to determine a length time that an operator is no longer present on the operator platform 114, i.e., the length of time that the OP switch 162 is in the off state. Further, in one or more embodiments, the Parking Brake Timer can be utilized to determine a length of time that the ignition switch 134 has been in the off state for application of the parking brake 140.

After the OP Switch Timer and the Parking Brake Timer have been reset at 208, the ECU 164 can determine whether the transmission control input 116 is in the neutral state at 210. If the transmission control input 116 is not in the neutral state at 210, then the ECU 164 may manipulate the clutch 156 from the engaged state to the disengaged state (or confirm that the clutch is in the disengaged state) at 212. Further, the ECU 164 may also disable ignition of the engine 104 at 212. Stated another way, the operator cannot activate the engine 104 unless the transmission control input 116 is in the neutral state, the parking brake 140 is in the engaged state, and the clutch 156 is in the disengaged state. Such a configuration may ensure that the engine 104 is unloaded prior to activation (e.g., starting). Further, this configuration of logic 200 can prevent the mower 100 from rolling (forward or backward) when the operator attempts to start the engine 104 with the transmission control input 116 in either the forward state or the reverse state. The logic 200 then returns to start 202. As used herein, the phrase “disable ignition of the engine” means that the ECU 164 manipulates the engine 104 such that the engine is in the inoperative state, i.e., the engine cannot run or be started by the operator.

If, however, the transmission control input 116 is in the neutral state at 210, then the ECU 164 next determines whether the parking brake 140 is in the engaged state at 214. If the parking brake 140 is in the engaged state at 214, then the Parking Brake Timer is reset at 216, and the ECU 164 determines whether the ignition switch 134 is in the start state at 220. If, however, the parking brake 140 is in the disengaged (i.e., not engaged) state at 214, then the ECU 164 manipulates the parking brake to the engaged state at 218.

At 220, the ECU 164 determines whether the ignition switch 134 is in the start state. If the ignition switch 134 is in the start state at 220, then the ECU 164 manipulates the clutch 156 to the disengaged state at 222 and enables ignition of the engine 104 at 224, and the logic flow 200 returns to start 202 at 226. As used herein, the phrase “enables ignition of the engine” means that the ECU 164 manipulates the engine 104 such that the engine is in the operative state, i.e., the engine will either continue to run or is capable of being started by the operator. If the ignition switch 134 is not in the start state at 220, then the ECU 164 determines whether the ignition switch is in the run state at 228, and the logic 200 proceeds as is further described herein. As a result, the ECU 164 will allow the operator to start the mower 100 at 224 if the transmission control input 116 is in the neutral state, the parking brake 140 is in the engaged state, and the clutch 156 is in the disengaged state.

Returning to 205, if the ECU 164 determines that the ignition switch 134 has not been manipulated from the off state to the run state, then the ECU determines whether the ignition switch has been manipulated from the run state to the start state at 206. If the ignition switch 134 has been manipulated from the run state to the start state, then the ECU 164 determines whether the transmission control input 116 is in the neutral state at 210, and the logic 200 proceeds as already described herein. If, however, the ECU 164 determines that the ignition switch 134 has not been manipulated from the run state to the start state at 206, then the algorithm progresses to 228.

If the ignition switch 134 is not in the run state at 228, then the ECU 164 determines whether the ignition switch is in the off state at 230. If the ignition switch 134 is in the off state at 230, then the logic 200 proceeds to connecting point C of FIG. 5B at 232. The logic 200 returns to start 202 at 234 if the ignition switch 134 is not in the off state at 230.

If, however, the ignition switch 134 is in the run state at 228, then the ECU 164 determines whether the transmission control input (e.g., pedal) 116 is in the neutral state at 236. If the transmission control input 116 is not in the neutral state at 236, then the logic 200 proceeds to connecting point A of FIG. 5B at 238.

If, on the other hand, the transmission control input 116 is in neutral state at 236, then the ECU 164 stores the previous OP switch state at 237 and reads the current OP switch state at 239. The ECU 164 then determines whether the OP switch 162 is in the on state at 240, i.e., whether the operator is on the operator platform 114 of the mower 100. If the OP switch 162 is in the on state at 240, then the ECU 164 resets the OP Switch Timer at 242 and enables ignition of the engine 104 at 224. The logic 200 then returns to start 202 at 226. As a result, the operator can start the engine 104 of the mower 100 or the engine can continue to run at 224 if the transmission control input 116 is in the neutral state (at 236), the parking brake 140 is in the engaged state, and the operator is on the operator platform 114 (at 240).

If the OP switch 162 is determined to be in the off state (i.e., not on) at 240, then the ECU 164 at 244 compares the previous OP switch state 237 to the current OP switch state 239. If the previous OP switch state 237 is equal to the on state, then the ECU 164 starts the OP Switch Timer at 246 and manipulates the clutch 156 to the disengaged state at 222, enables ignition of the engine 104 at 224, and returns to start 202 at 226. As a result, the ECU 164 may be adapted to disengage the clutch 156 when the operator leaves the operator platform 114 (assuming the transmission control input 116 is in the neutral state) while leaving the engine in the operative state (at 224). In other words, when the operator leaves the operator platform 114 with the transmission control input 116 in the neutral state, the clutch 156 automatically disengages (i.e., the implement 118 is decoupled from the engine) and the engine 104 continues to run.

If, on the other hand, the previous OP switch state 237 is equal to the off state at 244, then the ECU 164 determines whether the parking brake 140 is in the engaged state at 248. If the parking brake 140 is in the engaged state at 248, then the ECU 164 resets the Parking Brake Timer at 256, manipulates the clutch 156 to the disengaged state at 222, enables ignition of the engine 104 at 224, and returns to start 202 at 226. If the parking brake 140 is in the disengaged state at 248, then the ECU 164 determines whether the OP Switch Timer is at a value that is greater than or equal to a preselected Brake Threshold Time (T_{B}) at 250. T_{B} can be any suitable value, e.g., greater than or equal to 0 seconds, no greater than 5 seconds, etc. For example, in one or more embodiments, T_{B} can be 1 second. If the OP Switch Timer is at a value that is greater than or equal to T_{B} at 250, then the ECU 164 manipulates the parking brake 140 to the engaged state at 252, resets the OP Switch Timer at 254, disengages the clutch 156 at 222, enables ignition of the engine 104 at 222, and returns to start 202 at 226. If the OP Switch Timer has a value that is less than T_{B} at 250, then the ECU 164 disengages the clutch 156 at 222, enables ignition of the engine 104 at 224, and returns to start 202 at 226. As a result, blocks 240-256 of flow 200 can allow the operator to leave the platform (with the transmission control input 116 in the neutral state) while automatically: disengaging the clutch 156, engaging the parking brake 140, and maintaining the engine in its operative or running state.

Returning to 228, if the ECU 164 determines that the ignition switch 134 is in the run state and the transmission control input 116 is not in the neutral state at 236, then at 238 the logic 200 proceeds to connecting point A of FIG. 5B. The ECU may then determine whether the OP switch 162 is in the on state at 260. If the OP switch 162 is in the on state at 260, then the ECU 164 resets the OP Switch Timer at 262 and proceeds to determine whether the parking brake 140 is in the engaged state at 264. If, however, the OP switch 162 is in the off state at 260, then the ECU 164 determines whether the parking brake 140 is in the engaged state at 268. At 264, if the parking brake 140 is in the engaged state, then the ECU 164 manipulates the parking brake to the disengaged state at 266 and proceeds to determine whether the parking brake is still engaged at 268, i.e., the ECU determines whether the parking brake has not been manipulated from the engaged state to the disengaged state at 266. If the attempt to disengage the parking brake at 266 has failed, then the ECU 164 at 270 disengages the clutch 156, disables ignition of the engine 104, and returns to start 202 of FIG. 5A.

If the ECU 164 determines at 268 that the parking brake 140 has been successfully disengaged at 266, then the ECU stores the previous OP switch state at 269 and reads the current OP switch state at 271. At 272, the ECU 164 determines whether the OP switch 162 is in the on state at 272, i.e., whether the operator is on the operator platform 114. If the OP switch 162 is in the on state at 272, then the ECU 164 resets the OP Switch Timer at 274, and logic 200 returns to connecting point B of FIG. 5A at 276, where the ECU enables ignition of the engine 104 at 224 and returns to start 202 at 226. If, however, the OP switch 162 is in the off state at 272, then the ECU 164 compares the previous OP switch state 269 to the current OP switch state 271. If the previous OP switch state 269 is equal to the on state, then the ECU 164 starts the OP Switch Timer at 280, and the logic 200 returns to connecting point B of FIG. 5A at 276.

If, on the other hand, the previous OP switch state 269 is not equal to the on state, then the ECU 164 determines whether the OP switch 162 has been in the off state for greater than or equal to a First OP Switch Threshold Time (T_{S1}) at 282, i.e., whether the OP Switch Timer has a value that is greater than or equal to T_{S1}. T_{S1} can be any suitable length of time, e.g., greater than 0 seconds, no greater than 5 seconds, etc. In one or more embodiments, T_{S1} can be equal to 0.5 seconds. If the OP Switch Timer is greater than or equal to T_{S1} (e.g., 0.5 seconds) at 282, then the ECU 164 resets the OP Switch Timer at 284, and the ECU disengages the clutch 156, disables ignition of the engine 104, and returns to start 202 at 286.

If, however, the value of the OP Switch Timer is less than T_{S1} at 282, then the ECU 164 determines whether the value of the OP Switch Timer is greater than or equal to a Second OP Switch Threshold Time (T_{S2}) and less than T_{S1} at 302. T_{S2} can be any suitable length or period of time, e.g., greater than 0 seconds, no greater than 5 seconds, etc. In one or more embodiments, T_{S2} can be equal to 0.2 seconds. If yes, then the logic 200 proceeds to connecting point D at 304 and returns to FIG. 5A, where the logic disengages the clutch 156 at 222, enables ignition of the engine 104 at 224, and returns to start 202 at 226. If the OP Switch Timer value is less than T_{S2}, then the logic 200 proceeds to connecting point B at 276, returning to FIG. 5A, where the logic enables the ignition of the engine 104, and returns to start 202 at 226. As a result, if the mower 100 is moving and the operator has been detected to have just left the operator platform 114, the algorithm 200 will allow, e.g., 0.2 seconds of normal operation to allow for bouncing or readjusting of the operator on the platform due, e.g., to rough terrain. If the OP switch 162 remains in the off state for longer than, e.g., 0.2 seconds, then the ECU 164 manipulates the clutch 156 to the disengaged state. Further, if the operator is off the operator platform 114 (i.e., the OP switch 162 is in the off position) for longer than, e.g., 0.5 seconds, then the engine 104 is manipulated to the inoperative state. If the operator returns to the operator platform 114 before, e.g., 0.5 seconds have elapsed, then the OP Switch Timer is reset.

In one or more embodiments, the mower 100 can be adapted to engage the parking brake 140 when the ignition switch 144 is in the off state. For example, returning to 230 of FIG. 5A, if the ECU 164 determines that the ignition switch 134 is in the off state, then the logic 200 proceeds to connecting point C at 232 of FIG. 5B, and the ECU further determines whether the parking brake 140 is in the engaged state at 288. If the parking brake 140 is engaged at 288, then the ECU 164 resets the Parking Brake Timer at 290, disengages the clutch 156, disables ignition of the engine 104, and returns to start 202 at 292. If, however, the ECU 164 determines that the parking brake 140 is disengaged at 288, then the ECU 164 compares the previous ignition switch state 203 to the current ignition switch state 204 at 294. If the previous ignition switch state 203 is equal to either start or run, and the current ignition switch state 204 is off (i.e., the ignition switch has just been manipulated from either run or start to off), then the ECU 164 starts the Parking Brake Timer at 296, disengages the clutch 156, disables ignition of the engine 104, and returns to start 202 at 292.

If, however, the ECU 164 determines that the previous ignition switch state 203 was off at 294, then the ECU at 298 determines whether the Parking Brake Timer has a value that is greater than or equal to an Ignition Switch Off-State Threshold Time (T₁). T₁ can be any suitable length of time, e.g., greater than 0 seconds, no greater than 10 seconds, etc. In one or more embodiments, T₁ can be equal to 7 seconds. If the Parking Brake Timer has a value that is greater than or equal to T₁ at 298, then the ECU 164 manipulates the parking brake 140 to the engaged state at 300 and resets the Parking Brake Timer at 290, disengages the clutch 156, disables ignition of the engine, and returns to start 202 at 292. If, however, the ECU 164 determines that the Parking Brake Timer has a value that is less than T₁, then the ECU disengages the clutch 156, disables ignition of the engine 104, and returns to start 202 at 292.

As described herein, the present disclosure provides various embodiments of a grounds maintenance vehicle. The vehicle can include an electronic control system having an electronic control unit (ECU) that is in electrical communication with one or more of a transmission control input, a power take off (PTO) clutch, a parking brake, and an operator presence (OP) switch. In one or more embodiments, the ECU can be adapted to manipulate the clutch from an engaged state to a disengaged state, thereby decoupling an engine of the vehicle from an implement supported by a chassis of the vehicle, when operator presence is no longer detected, e.g., when an operator of the vehicle has left an operator platform of the vehicle (e.g., a seat), i.e., the OP switch changes to an off state. Further, the ECU may allow the engine to remain in an operative state when the OP switch is in the off state.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. A grounds maintenance vehicle comprising:
a chassis;
an engine supported by the chassis, the engine comprising an operative state and an inoperative state;
an implement supported by the chassis;
a ground engaging drive member connected to the chassis and operable to propel the vehicle over a ground surface;
a transmission operatively connected between the engine and the ground engaging drive member, wherein the transmission comprises forward, neutral, and reverse states;
a transmission control input operatively connected to the transmission, wherein the transmission control input comprises forward, neutral, and reverse states corresponding to the forward, neutral, and reverse states of the transmission, respectively;
a clutch operatively connected between the engine and the implement, the clutch adapted for selective manipulation between a disengaged state, wherein the engine is operatively decoupled from the implement, and an engaged state, wherein the engine is operatively coupled to the implement;
a parking brake having an engaged state adapted to immobilize the ground engaging drive member, and a disengaged state;
an operator presence (OP) switch having an off state corresponding to an operator platform of the ground maintenance vehicle being vacant, and an on state corresponding to the operator platform being occupied; and
an electronic control unit (ECU) in electrical communication with the transmission control input, clutch, parking brake, and OP switch;
wherein in response to a pre-defined operator activity, the ECU is adapted to manipulate the clutch from the engaged state to the disengaged state, while the engine remains in the operative state, when the transmission control input is in the neutral state and the OP switch changes from the on state to the off state.

2. The vehicle of claim 1, wherein the ECU is further adapted to manipulate the parking brake from the engaged state to the disengaged state when the transmission control input is manipulated from the neutral state.

3. The vehicle of claim 2, wherein the ECU is further adapted to manipulate the parking brake from the disengaged state to the engaged state if the OP switch is in the off state and the transmission control input is in the neutral state.

4. The vehicle of claim 1, wherein the ECU is further adapted to manipulate the clutch from the engaged state to the disengaged state and the engine from the operative state to the inoperative state when the park brake is in the engaged state and the transmission control input is in either the forward state or the reverse state.

5. The vehicle of claim 1, wherein the ECU is further adapted to manipulate the clutch from the engaged state to the disengaged state and the engine from the operative state to the inoperative state when the OP switch is in the off state and the transmission control input is in either the forward state or the reverse state.

6. The vehicle of claim 1, wherein the ECU is further adapted to manipulate the clutch from the engaged state to the disengaged state and maintain the engine in the operative state if the OP switch is in the off state and the transmission control input is in either the forward state or the reverse state.

7. The vehicle of claim 1, further comprising an operator-selectable power take-off (PTO) switch in communication with the clutch and the ECU, wherein the PTO switch comprises an off state corresponding to the disengaged state of the clutch and an on state corresponding to the engaged state of the clutch.

8. The vehicle of claim 1, wherein the transmission control input comprises a foot pedal mechanically coupled to the transmission, and two or more switches in electrical communication with the ECU.

9. The vehicle of claim 1, further comprising an ignition switch in communication with the engine and the ECU, wherein the ignition switch comprises an off state, a start state, and a run state.

10. The vehicle of claim 9, wherein the ECU is further adapted to manipulate the parking brake from the engaged stated to the disengaged state when the OP switch is in the on state, the ignition switch is in the run state, and the transmission control input is manipulated from the neutral state to either the forward state or the reverse state.

11. A grounds maintenance vehicle comprising:
a chassis;
an engine supported by the chassis and having an operative state and an inoperative state;
a ground engaging drive member connected to the chassis and operable to propel the vehicle over a ground surface;
a transmission operatively connected between the engine and the ground engaging drive member, wherein the transmission comprises forward, neutral, and reverse states;
a transmission control input mechanically connected to the transmission, wherein the transmission control input comprises forward, neutral, and reverse states corresponding to the forward, neutral, and reverse states of the transmission, respectively;
a parking brake having an engaged state adapted to immobilize the ground engaging drive member, and a disengaged state;
an electronic control unit (ECU) in electrical communication with the transmission control input, parking brake, and OP switch; and
an ignition switch in communication with the engine and the ECU, wherein the ignition switch comprises an off state, a start state, and a run state, and wherein the engine is in the operative state when the ignition switch is in either the run state or the start state, and further wherein the engine is in the inoperative state when the ignition is in the off state;
wherein the ECU, in response to a pre-defined operator activity, is adapted to manipulate the parking brake to the engaged state when the ignition switch is manipulated from the off state to either the run state or the start state and the transmission control input is in the neutral state.

12. The vehicle of claim 11, further comprising an implement supported by the chassis.

13. The vehicle of claim 12, further comprising a clutch operatively connected between the engine and the implement, the clutch in electrical communication with the ECU, wherein the clutch is adapted for selective manipulation between a disengaged state, wherein the engine is operatively decoupled from the implement, and an engaged state, wherein the engine is operatively coupled to the implement.

14. The vehicle of claim 13, further comprising an operator presence (OP) switch having an off state corresponding to an operator platform of the ground maintenance vehicle being vacant, and an on state corresponding to the operator platform being occupied.

15. The vehicle of claim 14, wherein in response to a second pre-defined operator activity, the ECU is further adapted to manipulate the clutch from the engaged state to the disengaged state while the engine remains in the operative state when the transmission control input is in the neutral state and the OP switch changes from the on state to the off state.

16. A grounds maintenance vehicle comprising:
a chassis;
an engine supported by the chassis, the engine comprising an operative state and an inoperative state;
an implement supported by the chassis;
a ground engaging drive member connected to the chassis and operable to propel the vehicle over a ground surface;
a transmission operatively connected between the engine and the ground engaging drive member, wherein the transmission comprises forward, neutral, and reverse states;
a transmission control input operatively connected to the transmission, wherein the transmission control input comprises forward, neutral, and reverse states corresponding to the forward, neutral, and reverse states of the transmission, respectively;
a clutch operatively connected between the engine and the implement, the clutch adapted for selective manipulation between a disengaged state, wherein the engine is operatively decoupled from the implement, and an engaged state, wherein the engine is operatively coupled to the implement;
a parking brake having an engaged state adapted to immobilize the ground engaging drive member, and a disengaged state;
an operator presence (OP) switch having an off state and an on state; and
an electronic control unit (ECU) in electrical communication with the transmission control input, clutch, parking brake, and OP switch;
wherein in response to a pre-defined operator activity, the ECU is adapted to manipulate the clutch from the engaged state to the disengaged state, while the engine remains in the operative state, when the transmission control input is in the neutral state and the OP switch changes from the on state to the off state.
